(19) United States
(12) Patent Application Publication
(10) Pub. No.: US 2015/0172245 A1
(43) Pub. Date: Jun. 18, 2015

(54) CONTACT-CENTRIC THREAD VIEWS FOR ELECTRONIC MESSAGE APPLICATIONS

(71) Applicant: Microsoft Corporation, Redmond, WA (US)

(72) Inventors: John Spivey, Redmond, WA (US); Geurt De Raad, Sammamish, WA (US); Ashish Bhangale, Redmond, WA (US); Yuhki Yamashita, Seattle, WA (US); Taylor Lehman, Seattle, WA (US); Dahey Yoo, Seoul (KR); John Morrow, Seattle, WA (US); Long Zhou, Renton, WA (US); Xerxes Beharry, Kirkland, WA (US); Mackenzie Bechtel-Hall, Kirkland, WA (US); Robert Tzeng, Redmond, WA (US)

(21) Appl. No.: 14/109,876

(22) Filed: Dec. 17, 2013

(51) Int. Cl. H04L 12/58; G06F 3/0481

(52) U.S. Cl. CPC H04L 51/16; H04L 51/046; G06F 3/0481

(57) ABSTRACT

A messaging application provides a user interface through which a user is presented a view of messages related to a selected contact. The message application processes messages based on contacts related to the messages. A user can select a contact and view the messages related to that contact. In a view of messages related to a contact, messages can be organized by threads, which include a plurality of messages from multiple entities. This view is generated based in part on a parameter of a message in each thread that is related to the selected contact. The threads can be ordered based on the last message in each thread from the selected contact. When selecting and displaying only unread messages, the system reveals threads which contain unread messages from the selected contact. A list of contacts that are frequent participants in messages can be identified automatically and set as favorites.

### BACKGROUND

The volume of electronic mail and other electronic messages received by individuals can be difficult to manage, if not overwhelming. Messaging applications on computers, such as electronic mail applications, generally provide ways to sort, search and filter messages according to user defined rules and various other parameters. Such sorting, searching and filtering and rule management tools in most electronic mail applications allow a user to create rules manually, to perform a sort, search or filter operation on messages based on available message parameters.

For example, most electronic mail applications allow a user to sort, search or filter messages in any selected folder by various message parameters or metadata, such as sent date, subject, to and from fields, and the like. Thus, such operations generally apply to message parameters. Also, such sorting and filtering typically is limited to a currently selected folder. To view messages outside a currently selected folder, an electronic mail application may allow a user to search, with such searching being performed manually based on keywords and/or available message metadata.

More sophisticated electronic mail applications allow a user to set up rules that automatically process incoming messages, based on message metadata or content. Typically the actions available involve processing messages that match certain criteria, such as moving a message into a folder, or other message processing commands within a limited set of commands (e.g., move, forward, reply, etc.) available in the application. Some rules, such as those for detecting junk mail and viruses, also may be built into an electronic mail application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A messaging application provides a user interface through which a user is presented a view of messages related to a selected contact. The message application processes messages based on contacts related to the messages. A user can select a contact and view the messages related to that contact. Contacts typically are individual people, but a contact also can be a group of people, a named contact such as a company, and the like.

In a view of messages related to a contact, messages can be organized by threads, which include a plurality of messages from multiple entities. This view is generated based in part on a parameter of a message in each thread that is related to the selected contact. For example, the threads can be ordered based on the last message in each thread from the selected contact, rather than the last message in the thread. As another example, when selecting and displaying only unread messages, the system reveals threads which contain unread messages from the selected contact, rather than showing all the threads that contain any unread message.

A contact can have multiple communication channels, e.g., multiple electronic mail addresses, through which the contact communicates with the user. The messaging application can process messages based on the contact; thus messages received or sent by the user through different communication channels, e.g., from different electronic mail addresses, can be processed as messages from the same contact. Thus, the view of messages related to a contact can include messages on all communication channels used by the contact. As another example, searching in a set of messages, such as a folder, for a selected contact results in searching for messages from the selected contact, using the multiple communication channels, rather than from a particular electronic mail address for that contact.

The messaging application can present an interface that allows a user to select a contact for which messages will be accessed. A list of contacts can be generated and presented based on contacts identified by the user as “favorites”. A list of contacts that are frequent participants in messages can be used to suggest contacts for selection as a “favorite”, and can be identified automatically by the messaging application. For example, contacts can be ranked based on a volume of messages related to each contact. Such identified contacts can be automatically set as favorites by the computer, or can be selected by the user.

In one aspect, a computer processes messages from contacts by receiving data into memory defining one or more contacts. An interface is provided which allows a user to select from among the one or more contacts. Given a selected contact, the computer identifies threads including messages related to the selected contact. In memory, a view of the identified threads is provided, wherein the view is generated based in part on a parameter of the message in each thread that is related to the selected contact. An interface is provided which presents the view to the user. This aspect can be embodied as a computer-implemented process, article of manufacture or a computer.

In another aspect, a computer comprises a selection module having an input receiving an indication of contacts, and an input receiving a selection, and an output providing an indication of a selected contact. A message viewer has an input receiving the indication of the selected contact and message data, and an output providing, to an interface, a view object providing a view of threads including messages related to the selected contact, wherein the view is generated based in part on a parameter of the message in each thread that is related to the selected contact. The selection module and message viewer can be implemented using a combination of computer program instructions in storage media and one or more processing units that process the computer program instructions.

In another aspect, contacts related to messages are ranked according to at least a volume of messages related to the contacts. One or more contacts from the ranked contacts can be automatically selected by a computer as favorite contacts. This aspect can be embodied as a computer-implemented process, article of manufacture or a computer.

In some implementations, for each identified thread, a most recent unread message in the thread related to the selected contact is identified. A view is provided in which the identified most recent unread message is displayed for each thread. The threads can be sorted in the view in order of date of the identified most recent unread message in the thread related to the selected contact.

In some implementations, for each identified thread, a most recent message in the thread related to the selected contact is identified. A view is provided in which the identified most recent message is displayed for each thread. The threads can be sorted in the view in order of date of the identified most recent message in the thread related to the selected contact.

In some implementations, message data is accessed to identify contacts for selected messages. The identified contacts are ranked according to at least a volume of messages related to the identified contacts. A list is presented in order of the ranking of the identified contacts. The ranking can be determined by computing a score for each of the identified contacts and ranking the identified contacts by the computed scores. The ranked contacts can be identified in a list of favorite contacts. The user can be allowed to select a contact from the presented list of contacts as a favorite contact. The selected contact can be added to a list of favorite contacts. A contact can be automatically selected from the ranked list of contacts and added to the list of favorite contacts.

In some implementations, the view is generated by a mail client application, or a mail server or a combination of both.

In some implementations, a contact can have multiple communication channels through which the contact communicates with the user, and messages over these different communication channels are processed as messages from the same contact.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example operating environment in which a messaging application can be implemented.

FIG. 2 is a data flow diagram illustrating an example implementation of a view generator.

FIG. 3 is a diagram of an illustrative example of message and thread data.

FIG. 4 is a diagram of an illustrative example of a graphical user interface showing contacts.

FIG. 5 is a diagram of an illustrative example of a graphical user interface showing threads associated with a contact.

FIG. 6 is a flow chart describing an example implementation of how a list of frequent participants in messages can be generated.

FIG. 7 is a block diagram of an example computing device with which components of such a system can be implemented.

### DETAILED DESCRIPTION

The following section provides an example operating environment in which a messaging application can be implemented. The following example is based on an electronic mail application, but can be applied to any messages received from contacts over multiple communication channels.

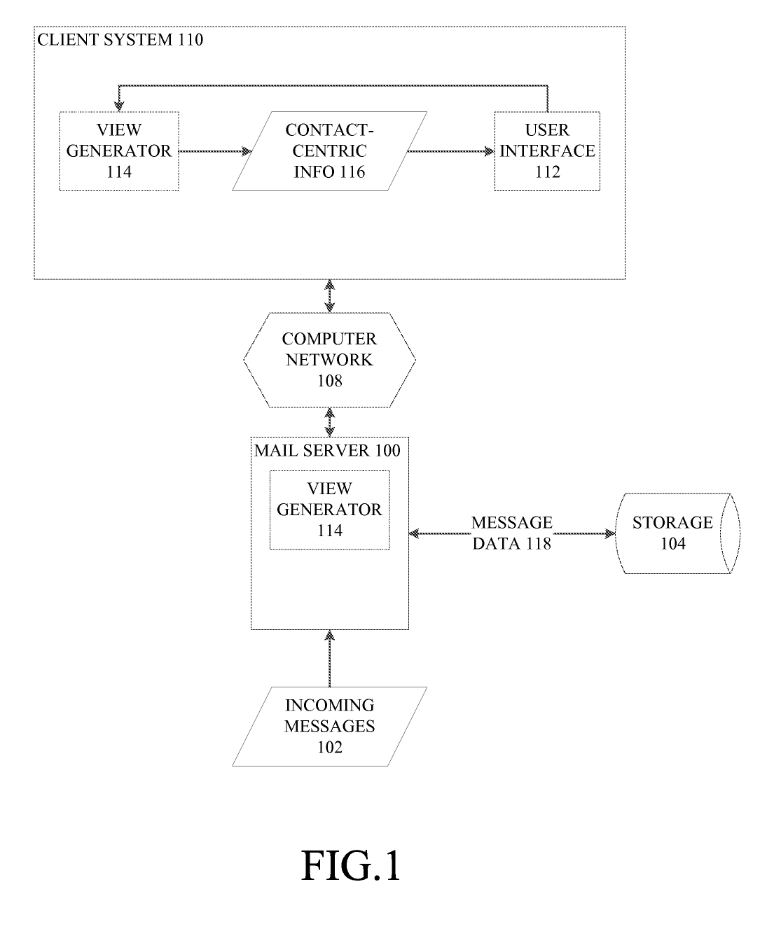

Referring to FIG. 1, a computer system includes a mail server 100 that processes incoming messages 102 and directs message data 118 from messages 102 to storage 104, organized by recipient. Incoming messages can come from any of a number of sources, and generally are received over a computer network, such as the internet or a private network. With electronic mail, messages are directed to the recipient at the mail server, using the recipient's electronic mail address.

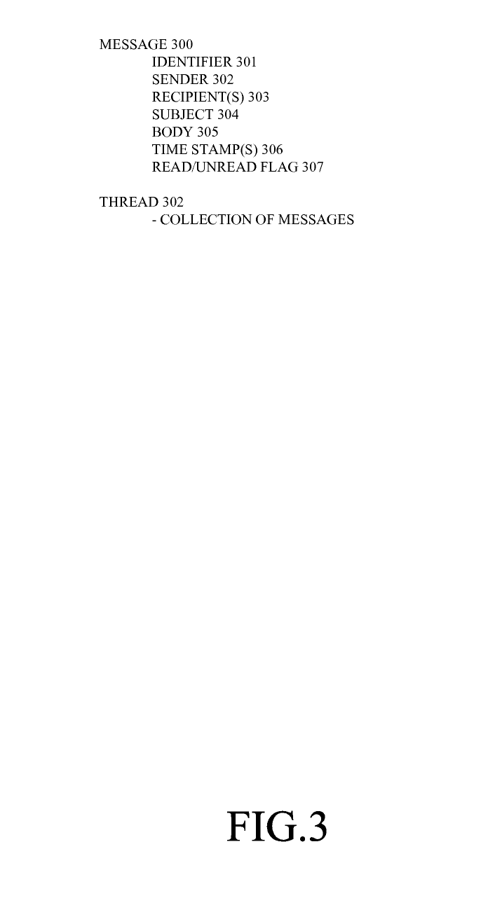

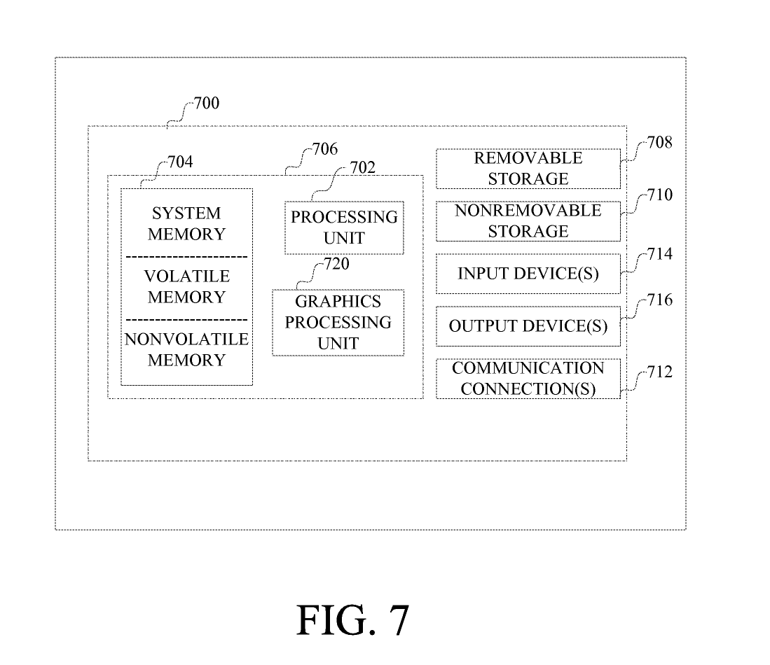

With electronic mail, each recipient has associated storage on the mail server 100, commonly referred to as a “mailbox”, in which message data 118 for that recipient are stored. The recipient can be an individual or an entity. A more detailed example of a data structure that can be used to represent and store messages and collections of messages is described in more detail below in connection with FIG. 3. The mail server 100 can be implemented using one or more server computers such as described in more detail below in connection with FIG. 7, using conventional mail server technology commonly used for electronic mail, such as an OUTLOOK mail server available from Microsoft Corporation or similar mail server.

A client system 110 allows the mailbox of a recipient to be accessed, and in turn to allow messages in the mailbox to be accessed. Such access typically is controlled through access credentials such as a user name and password. After access to a mailbox is authorized, the client system can access information about the messages stored in storage 104 for that recipient.

The client system 110 typically is a client computer, such as described below in connection with FIG. 7, running a client mail application that accesses the mail server 100 over a computer network 108. An example client mail application is a browser application that accesses a browser interface for the mail server 100. Such browser applications generally present information about messages to a user, but generally do not download messages for permanent storage on the client system 110. Another example client mail application is a client application that downloads messages from the mail server 100 for permanent storage on the client system 110.

The client system 110 includes a user interface 112 to a user through which the user can search, sort and filter sets of messages, organize messages into collections such as folders, select messages for reading, create new messages, store and/or delete messages, and perform a variety of other operations. The user interface 112 includes one or more output devices that present information from the client system 110 to the user and one or more input devices through which input from the user is received and directed to the client system 110.

The user interface 112 provides contact-centric thread views using the messages. In particular, a view generator 114 accesses message data 118 from the storage 104 to generate contact-centric information 116 which is provided to the user interface 112. The view generator also receives inputs through the user interface 112. An example of a graphical user interface that implements such contact-centric information 116 is described in more detail below.

The view generator 114 can reside in a server computer associated with the mail server 100. Alternatively, the view generator can reside in a client computer associated with the client system 110. Alternatively, a portion of the view generator can reside on the client system while another portion of the view generator can reside on the mail server. Thus, the alternate implementations are represented by dotted lines in FIG. 1.

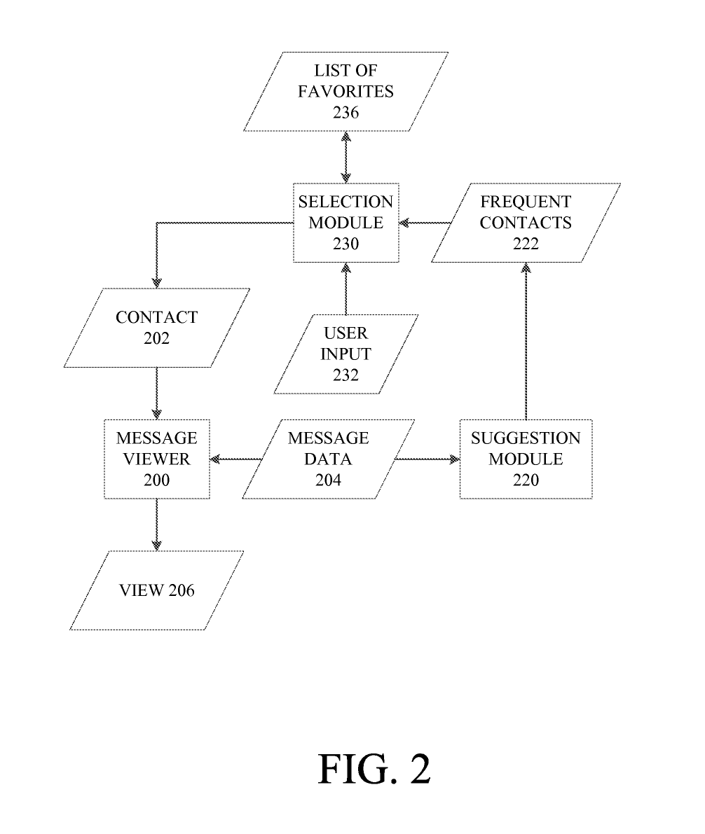

An example implementation of the view generator 114 is described in more detail in connection with FIG. 2. In this example, the view generator includes, on the one hand, a message viewer 200 that, given a contact 202, accesses message data 204 for a user (e.g., in that user's mailbox) and related to the selected contact to generate a view 206. A view is the data used to present information about the messages to the user through a user interface. For example, the view can be a list of threads containing messages related to the selected contact. This list can be ordered based in part on a parameter of the message in each thread that is related to the selected contact.

A suggestion module 220 accesses message data 204 to identify contacts 222 to suggest as possible contacts for which such a view can be created. A selection module 230 receives the suggested contacts 222 and user input 232 to maintain a list of favorites 236 for which the message viewer 200 can generate views 206. The contact 202 can be selected from the suggested contacts 222 and/or the list of favorites 236. In general, the message viewer 200 can generate, in memory, the data for the views for the suggested contacts 222 and the contacts in the list of favorites 236, but only passes on a single view to the user interface based on a selected contact. The message data 204 can reside in storage on the mail server, or can be a copy of the message data that is stored locally on the client system.

Given this context, an example implementation of the user interface and view generator will be described in more detail in connection with FIGS. 3-6.

FIG. 3 provides an illustrative example of message data that can be stored in a mail server. This example is intended to merely illustrative and not limited, as mail systems have a variety of ways of representing and storing data for messages. For the purposes of this example, a message 300 generally has an identifier 301, and includes a sender 302, one or more recipients 303, a subject 304 and a body 305. Various other metadata for a message can include a sent and/or received time stamps (typically including a date and time) 306, and a read or unread flag 308.

A thread 320 generally has an identifier 322, and represents a collection of related messages 300. There are a variety of ways of identifying and/or representing threads. A message can include data, such as a thread identifier, indicating one or more threads to which the message belongs. A mail server typically represents a thread using such thread identifiers stored on a message. A thread also can be defined by data indicating messages belonging to the thread. A client application typically represents a thread as a collection of messages, typically recognizing them by matching messages that share the same subject. A thread can be represented by a variety of data structures, for example, a sorted list of message identifiers.

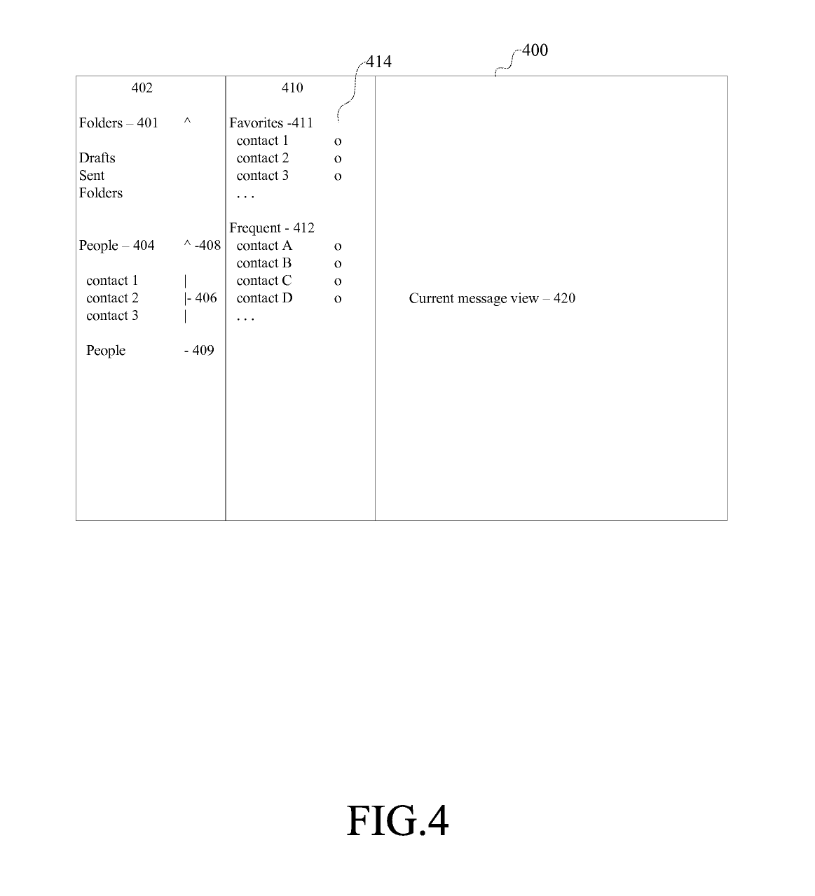

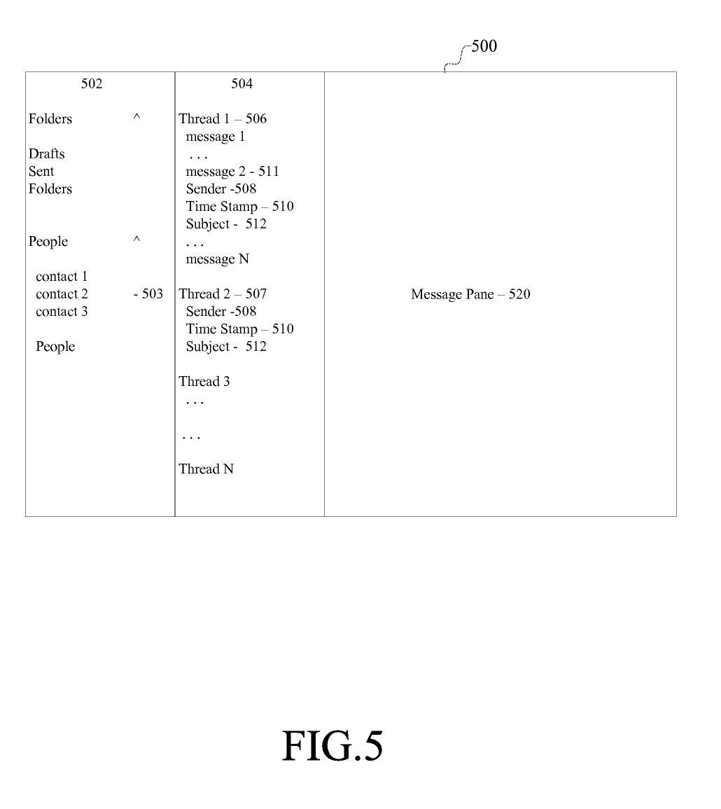

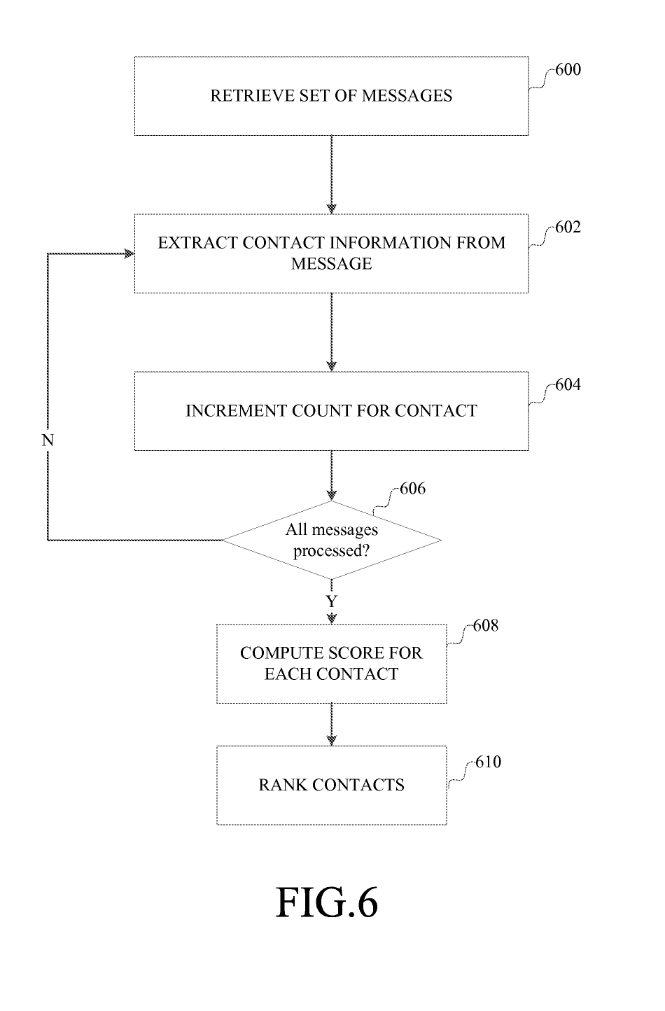

FIG. 4 provides an example graphical user interface 400 for an electronic mail application that illustrates how a view of messages for contacts can be displayed. In this example, a left-most pane 402 lists different available views for the electronic mail application, such as various folders 401 that are available. One of the views, namely people view 404, lists specifically selected people as indicated at 406, called favorites. An icon 408 can be manipulated by a user (through appropriate gestures through an input device) to expand or hide the list of favorites 406. An item 409, when manipulated, expands the display to provide a pane 410 of a list 411 of the favorites and a list 412 of frequent contacts. The frequent contacts are those contacts with whom messages have been most frequently exchanged with the recipient. An example implementation of how the list 412 of contacts can be generated is described in more detail below in connection with FIG. 6. Each of the frequent and favorite contacts can have an associated icon 414 that when manipulated by the user allows the contact to be added to or removed from the favorites list. Any individual in the list of favorites or list of frequent contacts can be selected, causing a view for messages from that contact to be displayed (See FIG. 5.) While people are being navigated by the user, the current message view is retained in the display in the current message view 420.

An example implementation of a graphical user interface 500 that displays a view for messages from a selected contact is shown in FIG. 5. The view can be represented by a view object created for the contact that includes a list of all threads and messages in those threads among the user's messages in which the contact is participating. Such a view can be independent of the folders in which the messages are stored.

In this example, the left-most pane 502 is the same as in FIG. 4, but with the selected contact highlighted as indicated at 503. A thread list pane 504 displays the threads, e.g., 506 and 507, in which messages related to this contact occur. The threads are ordered based on the time of the last message related to the selected contact, such as the last message received from the selected contact. For example, the thread 506 is represented in the view by showing the sender name 508, time stamp 510, and subject 512 of the most recent message 511 from the selected contact. In FIG. 5, the position of thread 506 in the list is based on the time stamp 510 of the most recent message from the selected contact in this thread. This most recent message from the selected contact in the thread also is used to represent the thread in the display when the view of the thread is collapsed, such as at 507. Selection of a thread by the user results in the view of that thread being expanded, as shown at 506, to show all the messages in that thread. Selection of a message in the thread results in the view of the message being provided in a message pane 520.

The thread list can show all messages, or can be filtered such as to show only unread messages. When selecting and displaying only unread messages, the system reveals threads which contain unread messages from the selected contact, rather than showing all the threads that contain any unread mail. A search can be performed within this thread view.

A messaging application also can identify messages as being related to a contact, instead of a single electronic mail address. In other words, a contact can have multiple communication channels, e.g., multiple electronic mail addresses, through which the contact communicates with the user. The messaging application can process messages based on the contact; thus messages received or sent by the user through different communication channels, e.g., from different electronic mail addresses, can be processed as messages from the same contact. Thus, the view of messages related to a contact can include messages on all communication channels used by the contact. As another example, searching in a set of messages, such as a folder, for a selected contact results in searching for messages from the selected contact, rather than from a particular electronic mail address for that contact.

Referring now to FIG. 6, an example implementation of a process for selecting frequent contacts will now be described. A variety of different implementations of this process are possible. Thus, the following is merely an illustrative example and not intended to be limiting.

A set of selected messages is retrieved 600 from the user's message store, such as the electronic mail account of the user. The set of messages can be limited to a particular period of time, for example. In some implementations, both sent messages and received messages can be considered. From each message, the contact information is extracted 602. For a received message, the sender is extracted. For a sent message, the recipient(s) is/are extracted. A count of the number of messages for each contact is incremented 604. Separate counts can be maintained for when the contact is a recipient or a sender. Also, each count can be weighted by its recency. This process is repeated for each message until all messages have been processed, as indicated at 606. At this point, one or more counts for each contact are obtained.

A function is applied to the available data, including but not limited to the counts obtained for each contact, to compute 608 a score for each contact, by which the contacts can be ranked 610. An example scoring algorithm is a weighted combination of the count for a contact as a sender, the count for the contact as a recipient and a value indicating whether the contact is in the user's contact list, or list of favorites. The list of ranked contacts can be passed to a user interface or other part of the system that uses the list of frequent contacts for this user. In one implementation, the top N contacts in the list of frequent contacts, where N is a positive whole number, e.g., 3, can be automatically marked as favorites.

As another example behavior of a user interface, notifications can be generated when messages are received from the contacts in a list of favorites or a list of frequent contacts. For example, if an electronic mail application is not currently active on a client computer, yet a background process is still communicating with the mail server, then the client computer can present an indication that a new message has been received for the client application. Such an indication can be limited only to messages received from “favorite” contacts. Such an indication can be placed on an icon representing the client application, for example.

Having now described an example implementation, FIG. 7 illustrates an example of an example computer in which such techniques can be implemented. This is only one example of a computer and is not intended to suggest any limitation as to the scope of use or functionality of such a computer.

The following description is intended to provide a brief, general description of a suitable computer with which such a system can be implemented. The computer can be any of a variety of general purpose or special purpose computing hardware configurations. Examples of well-known computers that may be suitable include, but are not limited to, game consoles, set top boxes, personal computers, hand-held or laptop devices (for example, media players, notebook computers, cellular phones, personal data assistants, voice recorders), server computers, multiprocessor systems, microprocessor-based systems, programmable consumer electronics, network PCs, minicomputers, mainframe computers, distributed computing environments that include any of the above systems or devices, and the like.

With reference to FIG. 7, an example computer 700, in a basic configuration, includes at least one processing unit 702 and memory 704. The computer can have multiple processing units 702. A processing unit 702 can include one or more processing cores (not shown) that operate independently of each other. Additional co-processing units, such as graphics processing unit 720, also are provided. Depending on the configuration and type of computer, memory 704 may be volatile (such as RAM), non-volatile (such as ROM, flash memory, etc.) or some combination of the two. This configuration is illustrated in FIG. 7 by dashed line 706. The computer 700 also may include additional storage (removable and/or non-removable) including, but not limited to, magnetic or optical disks or tape. Such additional storage is illustrated in FIG. 7 by removable storage 708 and non-removable storage 710.

A computer storage medium is any medium in which data can be stored in and retrieved from addressable physical storage locations by the computer. Computer storage media includes volatile and nonvolatile, removable and non-removable media. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices.

Computer 700 may also contain communications connection(s) 712 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 712 are devices that interface with the communication media to transmit data over and receive data from communication media, such as a network interface.

Computer 700 may have various input device(s) 714 such as a keyboard, mouse, pen, camera, touch input device, and so on. Output device(s) 716 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented using computer programs, which include computer-executable instructions and/or computer-interpreted instructions, which instructions are processed by one or more processing units in the computer. Generally, such instructions define routines, programs, objects, components, data structures, and so on, that, when processed by a processing unit, instruct the processing unit to perform operations on data. This computer system may be practiced in distributed computing environments where tasks are performed by remote processing devices that are linked through a communications network. In a distributed computing environment, computer programs may be located in both local and remote computer storage media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving data into memory defining one or more contacts;
providing an interface allowing a user to select from among the one or more contacts;
given a selected contact, identifying threads including messages related to the selected contact; and
providing, in memory, a view of the identified threads, wherein the view is generated based in part on a parameter of the message in each thread that is related to the selected contact; and
providing an interface presenting the view to the user.

2. The computer-implemented process of claim 1, wherein providing the view comprises:
for each identified thread, identifying a most recent unread message in the thread related to the selected contact;
providing a view in which the identified most recent unread message is displayed for each thread.

3. The computer-implemented process of claim 2, wherein providing the view comprises:
sorting the threads in the view in order of date of the identified most recent unread message in the thread related to the selected contact.

4. The computer-implemented process of claim 1, wherein providing the view comprises:
for each identified thread, identifying a most recent message in the thread related to the selected contact;
providing a view in which the identified most recent message is displayed for each thread.

5. The computer-implemented process of claim 4, wherein providing the view comprises:
sorting the threads in the view in order of date of the identified most recent message in the thread related to the selected contact.

6. The computer-implemented process of claim 1, wherein providing the interface allowing a user to select a contact comprises:
accessing message data to identify contacts for selected messages;
ranking the identified contacts according to at least a volume of messages related to the identified contacts; and
presenting a list in order of the ranking of the identified contacts.

7. The computer-implemented process of claim 6, wherein ranking comprises:
computing a score for each of the identified contacts; and
ranking the identified contacts by the computed scores.

8. The computer-implemented process of claim 6, wherein the contacts are contacts identified in a list of favorite contacts.

9. The computer-implemented process of claim 6, further comprising:
allowing the user to select a contact from the presented list of contacts as a favorite contact; and
adding any selected contact to a list of favorite contacts

10. The computer-implemented process of claim 6, further comprising:
automatically selecting a contact from the presented list of contacts as a favorite contact; and
adding the automatically selected contact to a list of favorite contacts.

11. The computer-implemented process of claim 1, wherein providing a view is performed by a mail client application.

12. The computer-implemented process of claim 1, wherein providing a view is performed on a mail server.

13. The computer-implemented process of claim 1, wherein a contact can have multiple communication channels through which the contact communicates with the user, and wherein messages over different communication channels are processed as messages from the same contact.

14. An article of manufacture comprising:
a computer storage medium;
computer program instructions stored on the computer storage medium which, when processed by a processing device, instruct the processing device to perform a process comprising:
receiving data into memory defining one or more contacts;
providing an interface allowing a user to select from among the one or more contacts;
given a selected contact, identifying threads including messages related to the selected contact; and
providing, in memory, a view of the identified threads, wherein the view is generated based in part on a parameter of the message in each thread that is related to the selected contact; and
providing an interface presenting the view to the user.

15. A computer comprising:
a selection module having an input receiving an indication of contacts, and an input receiving a selection, and an output providing an indication of a selected contact;
a message viewer having an input receiving the indication of the selected contact and message data, and an output providing, to an interface, a view object providing a view of threads including messages related to the selected contact, wherein the view is generated based in part on a parameter of the message in each thread that is related to the selected contact.

16. The computer of claim 15, wherein the message viewer is configured to, for each identified thread, identify a most recent unread message in the thread related to the selected contact and provide a view in which the identified most recent unread message is displayed for each thread.

17. The computer of claim 16, wherein the message viewer is configured to sort the threads in the view in order of date of the identified most recent unread message in the thread related to the selected contact.

18. The computer of claim 15, wherein the message viewer is configured to, for each identified thread, identify a most recent message in the thread related to the selected contact and provide a view in which the identified most recent message is displayed for each thread.

19. The computer of claim 15, wherein a contact can have multiple communication channels through which the contact communicates with the user, and wherein searching in a set of messages for a selected contact results in searching for messages from the selected contact using the multiple communication channels.

20. The computer of claim 15 wherein the message viewer is configured to rank contacts according to at least a volume of messages related to the contacts and automatically select one or more contacts from the ranked contacts as favorite contacts.
